(19) United States
(12) Patent Application Publication
(10) Pub. No.: US 2007/0263801 A1
(43) Pub. Date: Nov. 15, 2007

(54) Method for Addressing a Device in Behalf of Establishing a Communication Path Between a Telephony Network and a Data Network

(75) Inventor: Robert Scheltens, Oegstgeest (NL)

Correspondence Address: MICHAELSON & ASSOCIATES, P.O. BOX 8489, RED BANK, NJ, 07701, US

(73) Assignee: Koninklijke KPN N.V., The Hague (NL)

(21) Appl. No.: 11/660,124

(22) PCT Filed: Aug. 18, 2005
(86) PCT No.: PCT/EP05/08977

§ 371 Date: Feb. 13, 2007

(30) Foreign Application Priority Data
Sep. 8, 2004 (EP) 04077496.0

(51) Int. Cl. H04M 11/00

(52) U.S. Cl. 379/90.01

(57) ABSTRACT

A method is disclosed for addressing from a first device (1) in a telephony domain a second device (8) in a data communication domain for setting up a communication path between the first device (1) and the second device (8). Via a point of presence a connection can be established between the first device (1) and a domain (11). The domain (11) comprises a connect facility (4) to which an address identifier can be supplied via first device (1). Based on the address identifier the connect facility (4) defines the communication path between the first device (1) and the second device (8).

### FIELD OF THE INVENTION

The present invention relates to a method for addressing a destination device present in a data network domain when setting up a communication path from an originating device in the telephony domain.

### BACKGROUND OF THE INVENTION

Nowadays, voice over IP (VoIP) services are widespread. In the case of VoIP voice traffic is transported using a data communication protocol, i.e. the Internet Protocol (IP). VoIP can be applied on the Internet but is also possible to have VoIP available within a private network such as an in-company data network. In general, conversion is needed to convert the speech signal to be transported into a data signal that is suitable to be transported via a data communication protocol. Regarding the end-user equipment that is involved in VoIP, one can in general distinguish equipment that is related to the telephony domain and equipment that is related to the data communication domain. Equipment of the first category can for instance be a (mobile) telephone. Equipment of the latter category can for instance be a personal computer that comprises facilities for enabling speech communication. These facilities can be a microphone, a speaker, etc. There is also a distinction with regard to the way in which a VoIP call is set up. A VoIP call can be set up from a device in the telephony domain such as a telephone to a device in the data communication domain such as a personal computer or vice versa. It is also possible that a VoIP call is set up between two devices in the data communication domain, such as two personal computers. In all situations it is needed that the originator addresses the destination but the way in which this is done depends, amongst others, on the type of originating and destination equipment.

In WO 01/35605 a method is presented for providing telephony services via an IP network, in which case a telephone number is used to address the destination. This is the case if an end-user sets up a communication path using a telephone with another end-user that uses a computer device. A draw back of this prior art is that the destination then needs to be addressed by a telephone number which telephone number is not always available to the originating end-user. For instance, if the destination end-user is subscribed to an Internet Service provider (ISP) this end-user can be on-line from any location. The destination end-user is not limited to a specific physical location, so the telephone number associated with the actual physical location may be different each time. It would then not be possible for the originating end-user to set-up a communication path.

### AIM OF THE INVENTION

It is an object of the invention to eliminate the drawbacks of the prior art and to provide a method for addressing from a device in the telephony domain another device that is in the data communications domain without using a telephone number.

### SUMMARY OF THE INVENTION

In accordance with this invention, a method is disclosed for addressing from a first device in a telephony domain a second device in a data communication domain for setting up a communication path between the first device and the second device, the second device being connected to a domain of an Internet Service Provider, the method comprises the steps of setting up a connection between the first device and a connect facility in the Internet Service Provider domain using a telephone number and supplying said connect facility via said connection with an address identifier that is associated with the second device.

In a first aspect of the invention a method is disclosed for setting up a communication path from a first device in a telephony domain to a second device in a data communication domain. The device in the telephony domain can be a telephone, a mobile telephone or any other type of device via which telephony related services could be used. The end-user using the first device dials a telephone number in order to connect to a point of presence (PoP), via which the domain of an Internet Service Provider can be accessed. A PoP according to the present invention is unlike state of the art PoP's configured to handle voice traffic. Another advantage of the PoP's according to the invention is that it is possible to connect from a first device to the ISP's domain without being charged with long distance fees.

The domain of the ISP comprises a connect facility which enables the originating end-user to address the destination end-user without using a telephone number. For instance, a client number, address information, an URL address, an e-mail address or an IP address can be used to address the destination end-user or the device used by the destination end-user. For the ISP it is possible to provide the telephonedirectory with the telephone number via which the PoP's can be accessed and the client numbers of the end-users that are subscribed to that ISP. In such way the telephone number is publicly available. With this information other end-users, that are not subscribed to the ISP, can connect to the devices of the end-users subscribed to the ISP without having available the telephone numbers of the latter users. If the originating end-user is subscribed to the ISP, then it is possible for the ISP to make available the client numbers via a web page. If subscribers are connected to the Internet with fixed IP addresses, then it is possible to use these IP addresses for setting up communications paths between end-users for voice traffic without using the connect facility.

### BRIEF DESCRIPTION OF THE DRAWING FIGURE

The foregoing aspects and many of attendant advantages of this invention will become better understood by reference to the following detailed description, when taken in conjunction with the accompanying drawing, wherein:

FIG. 1 is a block diagram illustrating the concept of addressing a device in a data communication domain.

### EXEMPLARY EMBODIMENTS

For the purpose of teaching of the invention, preferred embodiments of the method and devices of the invention are described in the sequel. It will be apparent to the person skilled in the art that other alternative and equivalent embodiments of the invention can be conceived and reduced to practice without departing form the true spirit of the invention, the scope of the invention being limited only by the appended claims as finally granted.

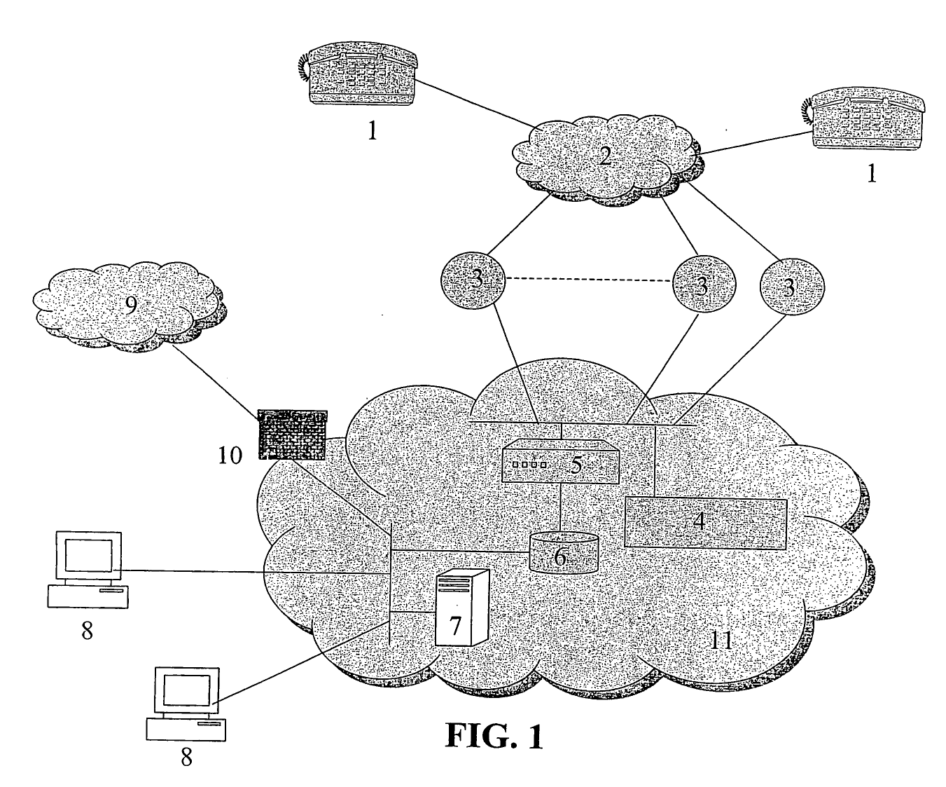

FIG. 1 shows a conceptual picture of the invention. A first device (1) is a device that can be used by an originating end-user (not depicted in the figure) for communication purposes. The first device (1) can, amongst others, be a telephone or a mobile telephone. In general, the first device (1) is used in a telephony domain in which telephony related services are provided such as voice services and SMS (short message service). A telephony domain comprises exchanges that route the telephony traffic. Also comprised by a telephony domain are facilities that provide signaling functionality. A well-known signaling system is signaling system no. 7 (SS no7). The first device (1) is connected to a telephony network (2). The telephony network (2) comprises one or more local exchanges. Between a first device (1) and a local exchange there often is a signaling procedure when a connected is set up via the first device (1). It may be possible that two first devices (1) are connected to the same local exchange in the case that both first devices (1) are located near each other. But the two first devices (1) are each connected to another local exchange in other cases. Via the telephony network (2) a point of presence (PoP, 3) can be reached. A PoP (3) is a dial-in facility capable of handling traffic originating from a first device (1). A PoP (3) comprises access equipment via which end-users using a first device (3) can connect to a domain (11) of an Internet service Provider. The PoP's (3) can be geographically located in such a way that the end-users using the first devices (1) are charged with local distance fees instead of long distance fees by the operator operating the telephony network (2), which is an advantage of the use of the PoP's (3). The PoP's (3) are able to handle voice traffic, including the signaling procedures needed to set a connection. Additionally, a PoP (3) may also comprise facilities for handling data traffic such as modems and other dial-in equipment.

A PoP (3) can be connected to the domain (11) of an Internet Service Provider via a leased line, although other types of connections are not excluded in the present invention. The domain (11) can be a location comprising different types of data communications related equipment. In the case of an Internet Service Provider, this equipment is based on the IP protocol, and other protocols and techniques that are related to IP (such as HTTP, FTP, and JAVA). Different types of equipment can be comprised by the domain (11) such as a local area network (LAN), servers, routers, and hosts. Also software and firmware can be comprised by the domain (11). In the set up phase for establishing a communication path between the first device (1) and a second device (8) the first device (1) is connected to a connect facility (4). The connect facility (4) is able to set up a communication path bases on a address identifier that is supplied by the end-user using the first device (1), i.e. the originating enduser. It can be sufficient to supply the connect facility (4) with one address identifier, but it may also the case that more than one address identifiers are needed to define the second device (the destination device). The address identifier can be a client number associated with the end-user that uses the second device (8). The client number can be provided by the Internet Service Provider to which the addressed end-user is subscribed. The originating end-user has to enter the client number via the first device (1) after there is established a connection between the first device (1) and the connect facility (4). However, it may also be possible that the client number is entered by the originating end-user during the establishing of the connection. In another embodiment the address identifier comprises address information such as a zip code. In yet another embodiment of the present invention the address identifier is information provided by the originating end-user via a voice response system comprised by the connect facility (4), for instance the name and the address of the destination end-user. Other types of information are not excluded in the present invention when considering the address identifier. An advantage of the usage of the connect facility (4) is that the originating end-user does not need a telephone number to set up a communication path to the destination end-user.

The second device (8) can, amongst others, be a personal computer. In general, the second device (8) is used in a data communication domain in which data communications related services are provided based, in this embodiment, IP. The second device (8) can be connected to the domain (11) of the Internet Service Provider via a dialed connection. It may be the case that for this purpose a point of presence is used that is integrated in the point of presence (3) that is used to connect the first device (1) to domain (11). However, it may also be the case that both access facilities to the domain (11) of the Internet Service Provider are separate. Domain (11) comprises a server (7) via which services are provided to the end-users using the second device (8) such as e-mail services, hosting services and access to the Internet. A firewall (10) is comprised by domain (11) for security purposes. There is also at least one router (6) in the local network of the Internet Service Provider.

When the communication path between the first device (1) and the second device (8) is defined using the connect facility (4) the traffic between both devices is routed through a converter facility (5). The converter facility (5) converts voice traffic into data traffic, the latter being in this embodiment VoIP.

1. Method for addressing from a first device in a telephony domain a second device in a data communication domain for setting up a communication path between the first device and the second device, the second device being connected to a domain of an Internet Service Provider, the method comprises the steps of setting up a connection between the first device and a connect facility in the Internet Service Provider domain using a telephone number and supplying said connect facility via said connection with an address identifier that is associated with the second device.

2. Method according to claim 1, in which via the connect facility upon receipt of the address identifier the communication path is set up, which communication path comprises a converter facility for the conversion between voice traffic and data traffic.

3. Method according to claim 1, in which the connection between the first device and the connect facility is set up via point of presence.

4. Method according to claim 1, in which a data communication protocol that used in the data communication domain is the Internet Protocol.

5. Method according to claim 1, in which the first device is a telephone.

6. Method according to claim 1, in which the second device is a personal computer.

7. Method according to claim 1, in which the address identifier is a code for identifying the second device that is entered via the first device in combination with the telephone number for connecting the first device and connect facility.

8. Method according to claim 7, in which the code is a client number associated with the user of the second device.

9. Method according to claim 7, in which the code is a zip code in combination with a home address.

10. Method according to claim 1, in which the connect facility comprises a voice response system, which receives via the first device the address identifier in the form of a spoken message.
